(19) United States
(12) Patent Application Publication
(10) Pub. No.: US 2020/0377281 A1
(43) Pub. Date: Dec. 3, 2020

(54) MULTIPLE COMPARTMENT CONTAINERS FOR MIXED DRINKS

(71) Applicant: Michael J. Picciallo, Dover, NJ (US)

(72) Inventor: Michael J. Picciallo, Dover, NJ (US)

(21) Appl. No.: 16/426,026

(22) Filed: May 30, 2019

(51) Int. Cl. B65D 81/32; B65D 85/72; B65D 17/00; B65D 75/58; A23F 5/36; A47J 31/00; A47G 19/22

(52) U.S. Cl. CPC B65D 81/3216; B65D 85/72; B65D 17/06; B65D 2221/00; A23F 5/36; A47J 31/005; A47G 19/2205; B65D 75/5855

(57) ABSTRACT

A mixed drink glass in which a shot glass affixed to the bottom of a mixing glass, wherein the volume of the mixing glass is larger than the volume of the shot glass.

### FIELD OF INVENTION

The present invention provides a shot glass in a drinking glass that is disposable or for permanent use. The drinking glass has a lid or a cover and can be insulated or non-insulated.

### BACKGROUND OF INVENTION

A mixed drink is a beverage in which two or more ingredients are mixed. Some mixed drinks contain liquor, i.e., defined herein as an ethanol or ethyl alcohol-containing liquid. Examples of alcohol-mixed drinks include gin and tonic, vodka and orange juice, and rum and cola, to name a few. The non-alcoholic beverage ingredient is referred to as a mixer. Occasionally the mixer is a lower alcohol content beverage.

Typically, the alcohol-containing ingredient is measured from a large bottle of spirits into a shot glass which is then poured into a drinking glass, either before or after the mixer is added to the drinking glass, with or without ice. Ice, when used, can be added in no particular order. Two glasses are required, and an implement to stir the drink. The host must keep in stock a bottle of every possible liquor a guest might request.

This works well in the context of a public drinking establishments or in homes furnished with a bar in the basement, family room or den. But for the occasional home mixologist without a bar area in their house, drink mixing accoutrements and ingredients tend to clutter the kitchen and often cannot be found when guests arrive. Complete mixology sets and all the bottles of liquor that might be requested are also cumbersome to carry and use at events such as picnics and barbecues.

The transporting of drink-mixing equipment and liquor is also cumbersome to caterers hired to serve mixed drinks at events. And there is an ever-present need to ensure their servers are not over-generous with their pour, as a matter of profitability and public safety.

Finally, mixed drink cocktails have enjoyed a resurgence in popularity. There are now literally thousands of cocktail recipes available and entire smart phone apps devoted to providing them to party hosts. Even if they can readily reference a recipe over the internet, it is not practical for the average host to have all the ingredients on hand that are needed for the many popular mixed drinks available today.

There remains a need among party hosts for a simpler way to serve mixed drinks that doesn't require stocking a large variety of ingredients and mixing equipment.

### SUMMARY OF INVENTION

This need is met by the present invention. The present invention solves this problem by combining these multiple components into a single article. In one embodiment, the present invention provides drinking glasses with built in shot glasses, each with a lid or cover for the drinking glass. The alcoholic beverage is added to the shot glass, after which the mixer and optional ice is added and the cover is secured to the drinking glass. The assembled container can then be shaken to mix the drink.

The invention can be used for portion control and convenient drink mixing when at home. In another embodiment a cover is provided for the shot glass, so that one can measure liquor into the shot glass, over which the cover is secured, so that the user can take the apportioned liquor to a separate location for mixing and consumption. That is, the apportioned liquor can be taken to a party, cookout or a Bring Your Own Bottle (BYOB) restaurant. The mixing glass cover serves as an extra seal to prevent spillage of the liquor. At the destination, both covers are removed, the mixer and optional ice are added, the mixing glass cover is replaced, and the drink is mixed by shaking. This eliminates the need to transport a full bottle of liquor and subsequently travel with open bottles of unused liquor. This embodiment of the invention can also be used by caterers to apportion liquor for dozens of mixed drinks in advance for subsequent mixing at an event. The drinks may be served in the container of the invention or poured into the drinking glasses used by the caterer.

The invention can also be used as a container for liquor distributors to market individual drinking glasses with shots of liquor for subsequent addition of the mixer and optional ice. In another embodiment, the shot glass is sealed with a removable cover having a pull tab, and contains liquor added at the bottling plant. The mixing glass in which the shot glass is positioned also has a removable cover that can be reattached, either by snugly fitting the rim of the drinking glass or by being a screw cap. The assembly would be offered wherever liquor is sold and taken to the purchaser's destination where the mixer and optional ice is added and the drink is mixed. This means of liquor distribution permits a group of people each to enjoy a reasonable number of different mixed drinks without having to purchase several different bottles of liquors.

In another embodiment, the drinking glass is a mug, or other type of cup for holding a hot beverage, such as coffee, with a built in shot glass, to mix liquor-containing coffee drinks. A liquor, such as Irish whiskey, can be added to the shot glass, after which the mug or cup is filled with coffee. As with the drinking glass embodiment, either or both the mug or cup and the shot glass can be provided with covers. And the shot glass of the mug or cup can also be used as a container for liquor distributors to market individual shots of liquor for subsequent addition of coffee.

In another embodiment, a kit is provided containing the drinking glass of the present invention with the built-in shot glass containing liquor, in which both the shot glass and drinking glass are covered, in combination with a sealed container of the mixer to be combined with the liquor. With such a kit, a party host is no longer required to know the difference between a Manhattan, an Old Fashioned and a Sazerac, three similar drinks, nor must they stock the ingredients for all three drinks. The present invention also provides kits containing a mug or a cup with a built-in shot glass containing liquor, in which both the shot glass and cup or mug are covered, in combination with a package of instant, ground or whole bean coffee to be brewed for mixing with the liquor.

This invention may be understood by reference to the drawing figures submitted herewith. Those skilled in the art will understand that various features of the drawings discussed below are not necessarily drawn to scale, and that dimensions of various features and elements of the drawings may be expanded or reduced to more clearly illustrate the embodiments of the present invention described herein. Furthermore, the drawings are for the purpose of illustration only and are not intended as a definition of the limits of the claimed embodiments.

### BRIEF DESCRIPTION OF THE DRAWINGS

FIGS. 1A and 1B depict side and top views of a drinking glass according to one embodiment of the invention.

FIGS. 2A and 2B depict side and top views of a drinking glass according to another embodiment of the invention.

FIGS. 3A and 3B depict side and top views of a drinking glass according to another embodiment of the invention.

FIGS. 4A and 4B depict side and top views of a drinking glass according to another embodiment of the invention.

FIGS. 5A and 5B depict side and top views of a drinking glass according to another embodiment of the invention.

FIGS. 6A, 6B, 6C and 6D depict side and top views of a drinking glass according to another embodiment of the invention.

### DETAILED DESCRIPTION

The present invention is illustrated with one type of drinking glass and other styles of glassware footed or unfooted may be used. For example, the glass can be a tumbler, goblet, ice tea glass, pint glass, pilsner glass, old fashioned glass, rocks glass, highball glass, hurricane glass, zombie glass or cocktail glass. For purposes of the present invention, “glass” is also defined as including a beer mug or coffee mug. Beer mug, pilsner glass or pint glass embodiments can be used, for example, to make boilermakers, in which a shot of whiskey is added to a serving of beer. The coffee mug embodiment can be used to make Irish coffee and other liquor-containing coffee drinks.

The term “glass” references tableware and not the material from which the tableware is made. The glass can be made of glass, ceramic, metal, plastic and other materials commonly used for tableware. The choice of material will depend on whether the product is intended to be reusable, disposable or recyclable. Reusable products may be designed as commemorative objects or keep-sakes.

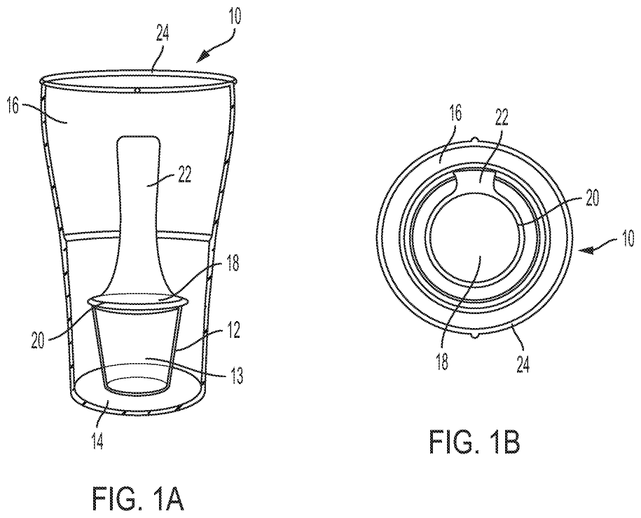

With reference to FIG. 1, a mixed drink glass 10 according to one embodiment of the invention is shown in FIG. 1A. Shot glass 12 containing liquor 13 is affixed by conventional means to the bottom 14 of mixing glass 16. FIG. 1B is a top view of the embodiment of FIG. 1A. A seal 18 affixed to the rim 20 of shot glass 12 so that liquor 13 does not leak from shot glass 12. Pull tab 22 of seal 18 extends upwardly toward drinking glass rim 24 so that the user does not have to reach deep into the drinking glass to remove the seal from the shot glass.

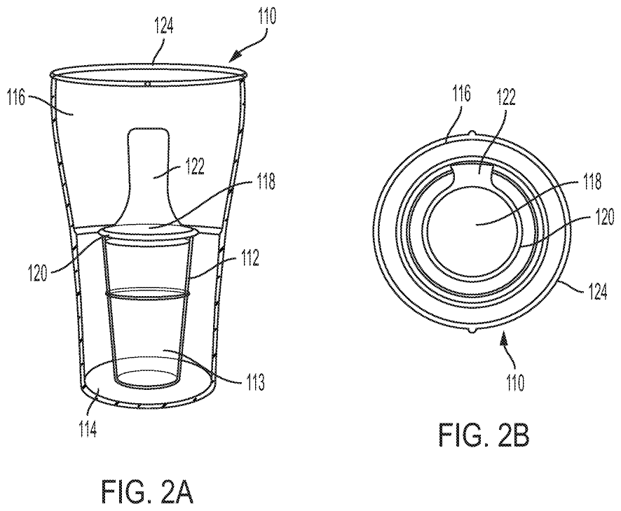

FIGS. 2A-2B depict side and top views of another embodiment according to the present invention in which the shot glass 12 of FIGS. 1A-1B is replaced with a larger type of shot glass 112, known as a shooter glass. Items 110, 113, 114, etc. of FIGS. 2A-2B correspond to items 10, 13, 14, etc. of FIGS. 1A-1B.

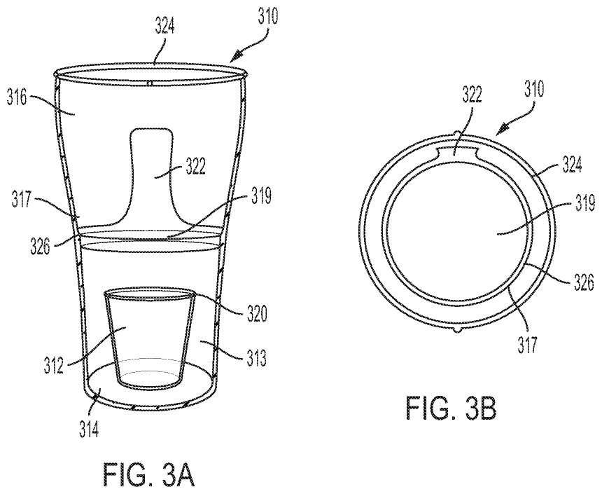

FIG. 3A depicts the embodiment if FIG. 1A in which a larger quantity of liquor is dispensed and a wider seal 319 secures the inner wall 317 of mixing glass 316 along the inner circumference 326. FIG. 3B is a top view of the embodiment of FIG. 3A. Items 310, 312, 313, 314, etc. of FIGS. 3A-3B correspond to items 10, 12, 14, etc. of FIGS. 1A-1B.

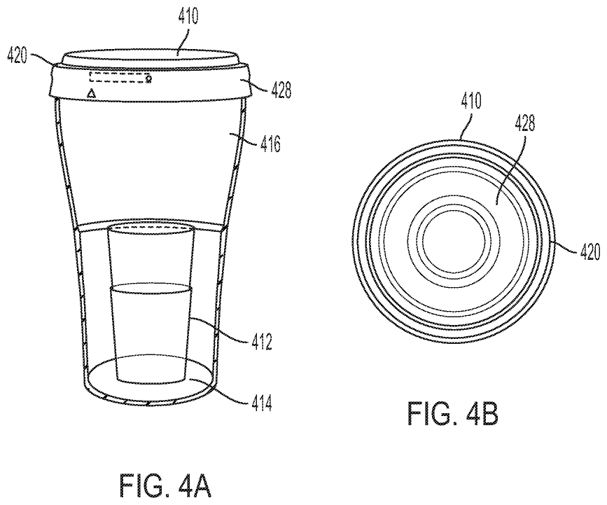

FIG. 4A depicts the embodiment of FIG. 1A formed from disposable or recyclable plastic, with disposable lid 428 snugly affixed to the rim 420 of mixing glass 416. FIG. 4B is a top view of the embodiment of FIG. 4A. The disposable lid 428 can be a screw cap, the interior rim of which contains channels (not shown) for receiving a thread (not shown) extending outwardly from below the rim 420 of drinking glass 416. Items 410, 412 and 414 of FIGS. 4A-4B correspond to items 10, 12 and 14 of FIGS. 1A-1B.

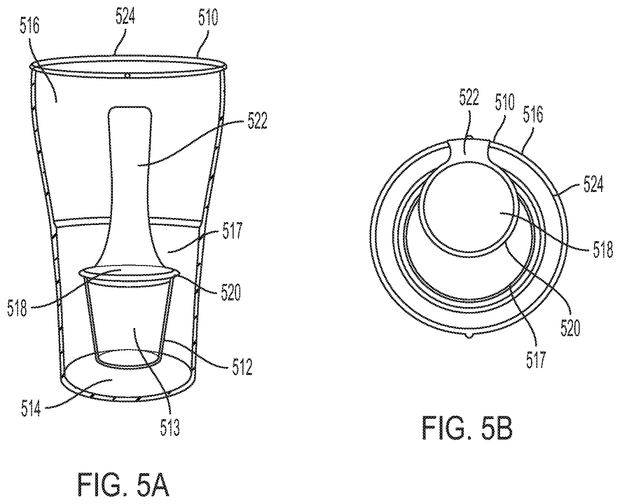

FIGS. 5A-5B depict side and top views of an embodiment in which shot glass 512 is affixed to the bottom 514 and the inner wall 517 of mixing glass 516. Items 510, 513, 518, etc. of FIGS. 5A-5B correspond to items 10, 13, 18, etc. of FIGS. 1A-1B. Shot glass 512 of FIGS. 5A-5B can be replaced with shooter glass 112 of FIGS. 2A-2B (not shown), or with the wider seal embodiment 319 of FIGS. 3A-3B securing the inner wall 317 of mixing glass 316 along inner circumference 326 (not shown). Shot glass 512 of FIGS. 5A-5B can also be positioned as in the embodiments of FIGS. 4A-4B, in which shot glass 412 is affixed to bottom 414 and inner wall 417 of mixing glass 416 (not shown).

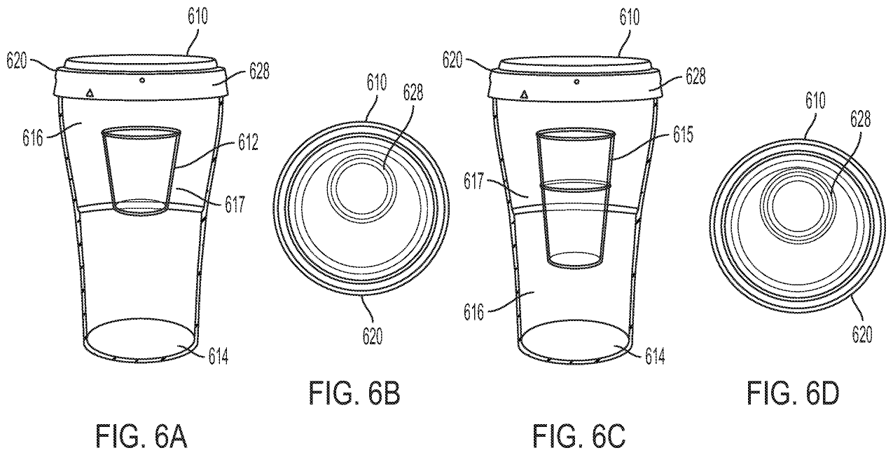

FIG. 6A depicts an embodiment in which shot glass 612 is not affixed to bottom 614 of mixing glass 616 but is instead affixed to inner wall 617 above bottom 614. FIG. 6B is a top view of the embodiment of FIG. 6A. FIGS. 6C and 6D depict side and top views of another embodiment according to the present invention in which shot glass 612 of FIGS. 6A and 6B is replaced with shooter glass 615. Items 610, 620 and 628 of FIGS. 6A-6D correspond to items 410, 420 and 429 of FIGS. 4A-4B.

In certain embodiments, the volume of the mixing glass ranges between four and sixteen times larger than the volume of the shot glass. In other embodiments, the volume of the mixing glass ranges between six and twelve times larger than the volume of the shot glass. In other embodiments the volume of the mixing glass ranges between four and eight times larger than the volume of the shot glass.

It should be understood that the present invention is not limited to mixing alcoholic beverages, and can also be used to mix two non-alcoholic beverages. Or a powdered flavoring can be stored in the shot glass for reconstitution with a liquid in the mixing glass.

In the drawings and the foregoing specification, the disclosure has been described with reference to specific exemplary embodiments. It will be evident that various modifications may be made without departing from the broader spirit and scope as set forth in the following claims. The specification and drawings are, accordingly, to be regarded as illustrative rather than in a restrictive sense.

While the methods and apparatuses have been described in terms of what are presently considered to be the most practical and preferred embodiments, it should be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A mixed drink glass comprising a shot glass affixed to the bottom of a mixing glass, wherein the volume of the mixing glass is larger than the volume of the shot glass.

2. The mixed drink glass of claim 1, wherein the shot glass contains a liquid and the shot glass is sealed with a removable cover.

3. The mixed drink glass of claim 2, wherein the removable cover of said shot glass comprises an integral pull tab extending upwardly toward the rim of said mixing glass.

4. The mixed drink glass of claim 2, wherein the mixing glass is sealed with a removable cover.

5. The mixed drink glass of claim 1, wherein the mixing glass is sealed with a removable cover.

6. The mixed drink glass of claim 5, wherein the removable cover is a screw cap.

7. The mixed drink glass of claim 2, wherein the liquid comprises ethanol.

8. The mixed drink glass of claim 1, wherein the mixing glass is a cup for holding a hot beverage.

9. The mixed drink glass of claim 8, wherein the cup is a coffee mug.

10. A kit comprising the mixed drink glass of claim 7, and a separate sealed container holding a mixer to be combined with the liquid comprising ethanol.

11. A kit comprising the mixed drink glass of claim 8, and a package containing instant, ground or whole bean coffee to be brewed and then combined with the liquid comprising ethanol.
